(19) United States
(12) Patent Application Publication
(10) Pub. No.: US 2011/0095615 A1
(43) Pub. Date: Apr. 28, 2011

(54) POWER SOURCE SELECTION CIRCUIT AND ELECTRONIC DEVICE USING THE SAME

(75) Inventors: ZHI-GUO LI, Shenzhen City (CN); SHIN-HONG CHUNG, Tu-Cheng (TW); HAN-CHE WANG, Tu-Cheng (TW); YI-LE GONG, Shenzhen City (CN); WEN-TAO WU, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/820,069

(22) Filed: Jun. 21, 2010

(30) Foreign Application Priority Data
Oct. 23, 2009 (CN) 200910308733.0

(51) Int. Cl. H02J 4/00

(52) U.S. Cl. 307/80

(57) ABSTRACT

A power source selection circuit includes an external power port and a battery compartment, which are used to connect to an external power source and a battery module, respectively. The power source selection circuit further includes a selection switch including a control terminal connected to the external power port, and a first path terminal connected to the battery compartment. A first unidirectional switch connects a second path terminal of the selection switch to a power output port. A second unidirectional switch connects the external power port to the output terminal. When the external power port is connected to the external power source, the control terminal of the selection switch is at a high voltage and the selection switch is cut off accordingly, thereby the path from the battery module to the power output port is cut off and the external power source provides power to the output port.

### BACKGROUND

1. Technical Field

The disclosure relates to power source circuits and, particularly, to a power source selection circuit and an electronic device using the circuit.

2. Description of Related Art

Nowadays, electronic devices (e.g., mobile phones and media players) are supplied with power from an external power source or a built-in battery. The external power source can be an AC/DC adapter which converts power from a wall outlet, or an interface (e.g., a USB interface) of another electronic device. If an electronic device receives power from the external power source and the built-in battery, it's better for the electronic device to select external power source to decrease the number of times the battery is charged and discharged.

A typical power source auto-switch device can switch between the built-in battery and the external power source for drawing power. However, the power source auto-switch device selects the built-in battery or the external power source according to the voltage of the built-in battery or the external power source, if the voltage of the built-in battery is higher than the external power source, the power source auto-switch device selects the built-in battery.

Therefore, a power source selection circuit capable of automatically selecting a power source is desired to overcome the above-described deficiencies.

### BRIEF DESCRIPTION OF THE DRAWINGS

The components in the drawings are not necessarily drawn to scale, the emphasis instead being placed upon clearly illustrating the principles of the power source selection circuit. Moreover, in the drawings, like reference numerals designate corresponding parts throughout the several views.

FIG. 1 is a block diagram showing a power source selection circuit in accordance with an exemplary embodiment.

FIG. 2 is a circuit diagram of the power source selection circuit of FIG. 1.

### DETAILED DESCRIPTION

Embodiments of the present disclosure will now be described in detail below, with reference to the accompanying drawings.

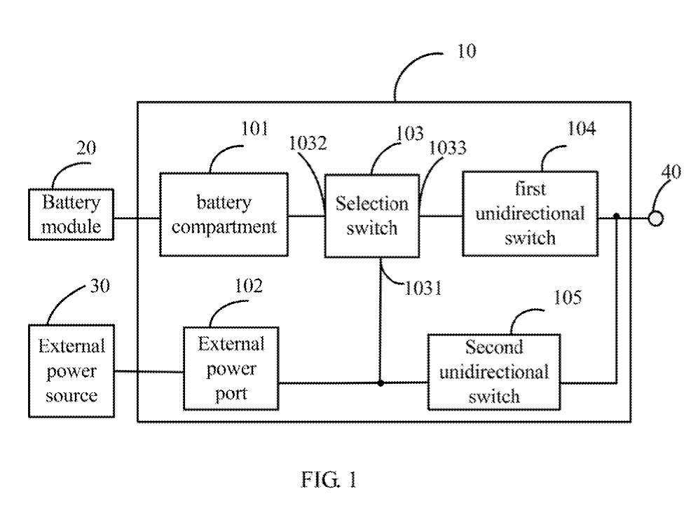

Referring to FIG. 1, an exemplary embodiment of a power source selection circuit 10 includes a battery compartment 101 for receiving a battery module 20 and an external power port 102 for connecting to an external power source 30. The external power port 102 can be a universal serial bus (USB) port, an IEEE1394 port or an AC/DC adapter port. The external power source 30 can be a USB power source, an IEEE1394 port power source, or an AC/DC adapter. The power source selection circuit 10 can be applied in an electronic device (not shown), such as a mobile phone, a media player, a digital photo frame, etc. The power source selection circuit 10 can automatically select the battery module 20 or the external power source 30 as a power source to power the electronic device. The power source selection circuit 10 includes an output terminal 40 for outputting power from the battery module 20 or the external power source 30 to the electronic device.

The power source selection circuit 10 further includes a selection switch 103, a first unidirectional switch 104, and a second unidirectional switch 105. The selection switch 103 includes a control terminal 1031, a first path terminal 1032, and a second path terminal 1033. The control terminal 1031 is connected to the external power port 102 and the first path terminal 1032 is connected to the battery compartment 101. The first unidirectional switch 104 is used to connect the second path terminal 1033 to the output terminal 40, and is used for guiding the power from the battery module 20 to the output terminal 40. The second unidirectional switch 105 is used to connect the external power port 102 to the output terminal 40 and is used for guiding the power from the external power source 30 to the output terminal 40. In the embodiment, the selection switch 103 is turned on when the voltage of the control terminal 1031 is low and is turned off when the voltage of the control terminal 1031 is high.

The power source selection circuit 10 selects the battery module 20 to power the electronic device via the output terminal 40 when only the battery module 20 is present, and the external power port 102 is not connected to the external power source 30. When the external power port 102 is connected to the external power source 30, the voltage of the control terminal 1031 becomes high, which causes the selection switch 103 to be turned off. Therefore, the electrical connection between the battery compartment 101 and the output terminal 40 is cut off, and the power source selection circuit 10 selects the external power source 30 to power the electronic device via the second unidirectional switch 105 and the output terminal 40.

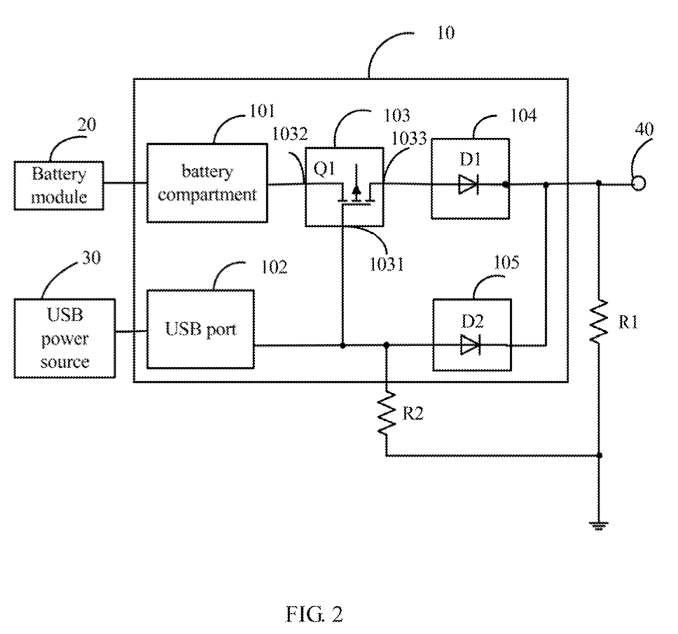

Referring to FIG. 2, in one embodiment, a USB port 102 is taken as an example to illustrate the external power port 102, and a USB power source 30 is taken as an example to illustrate the external power source 30. The first unidirectional switch 104 and the second unidirectional switch 105 are diodes D1 and D2, respectively. The anode (not labeled) and the cathode (not labeled) of the diode D1 are connected to the second path terminal 1033 and the output terminal 40, respectively. The anode (not labeled) and cathode (not labeled) of the diode D2 are connected to the anode of the external power port 102 and the output terminal 40 respectively.

The selection switch 103 is a p-channel metal-oxide-semiconductor field-effect transistor (PMOSFET) Q1. A gate (not labeled), a source (not labeled), and a drain (not labeled) of the PMOSFET Q1 constitute the control terminal 1031, the first path terminal 1032, and the second path terminal 1033 of the selection switch 103, respectively. The gate of the PMOSFET Q1 is connected to the anode of the external power port 102, the source of the PMOSFET Q1 is connected to the anode of the battery compartment 101, and the drain of the PMOSFET Q1 is connected to the anode of the diode D1.

If only the battery module 20 is present, the voltage of the gate of the PMOSFET Q1 is low turning on the PMOSFET Q1, thus the battery module 20 can provide power to the electronic device via the PMOSFET Q1, the diode D1, and the output terminal 40. When the USB power port is connected to the USB power source 30, the voltage of the gate of the Q1 becomes high, and the PMOSFET Q1 is thus turned off. Therefore, the electrical connection between the battery compartment 101 and the output terminal 40 is cut off, and the USB power source 30 provides power to the electronic device via the diode D2 and the output terminal 40.

The power source selection circuit 10 also includes resistors R1 and R2, which are taken as matched loads to match current output by the output terminal 40.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A power source selection circuit, comprising:
a battery compartment configured for receiving a battery module;
an external power port capable of being connected to an external power source;
an output terminal configured for outputting power from the battery module or the external power source to an electronic device;
a selection switch comprising a control terminal connected to the external power port, a first path terminal connected to the battery compartment, and a second path terminal;
a first unidirectional switch configured for connecting the second path terminal of the selection switch to the output terminal; and
a second unidirectional switch configured for connecting the external power port to the output terminal;
wherein, the selection switch is turned off and cut off the electrical connection between the battery module and the first unidirectional switch when the external power port is connected to the external power source, the external power source thus provides power to the electronic device via the second unidirectional switch and the output terminal.

2. The power source selection circuit according to claim 1, wherein the selection switch is a low voltage activated switch.

3. The power source selection circuit according to claim 2, wherein the selection switch is a p-channel metal-oxide-semiconductor field-effect transistor (PMOSFET), the control terminal, the first path terminal, and the second path terminal of the selection switch are the gate, the source, and the drain correspondingly.

4. The power source selection circuit according to claim 1, wherein both the first unidirectional switch and the second unidirectional switch are diodes.

5. The power source selection circuit according to claim 1, wherein the external power port is a USB power port configured for connecting to a USB power source.

6. The power source selection circuit according to claim 1, wherein the external power port is an AC/DC adapter port configured for connecting to an AC/DC adapter.

7. An electronic device comprising a power source selection circuit, the power source selection circuit comprising:
a battery compartment configured for receiving a battery module;
an external power port configured for connecting to an external power source;
an output terminal configured for outputting power from the battery module or the external power source to the electronic device;
a selection switch comprising a control terminal connected to the external power port, a first path terminal connected to the battery compartment, and a second path terminal;
a first unidirectional switch configured for connecting the second path terminal of the selection switch to the output terminal; and
a second unidirectional switch configured for connecting the external power port to the output terminal;
wherein, the selection switch is turned off and cut off the electrical connection between the battery module and the first unidirectional switch when the external power port is connected to the external power source, the external power source thus provides power to the electronic device via the second unidirectional switch and the output terminal.

8. The electronic device according to claim 7, wherein the selection switch is a low voltage activated switch.

9. The electronic device according to claim 8, wherein the selection switch is a p-channel metal-oxide-semiconductor field-effect transistor (PMOSFET), the control terminal, the first path terminal, and the second path terminal of the selection switch are the gate, the source, and the drain correspondingly.

10. The electronic device according to claim 7, wherein both the first unidirectional switch and the second unidirectional switch are diodes.

11. The electronic device according to claim 7, wherein the external power port is a USB power port configured for connecting to a USB power source.

12. The electronic device according to claim 7, wherein the external power port is an AC/DC adapter port configured for connecting to an AC/DC adapter.
